(19) United States
(12) Patent Application Publication
(10) Pub. No.: US 2012/0175241 A1
(43) Pub. Date: Jul. 12, 2012

(54) ROTATING DESORBER WHEEL

(75) Inventors: Asbjørn Strand, Bergen (NO); Torbjørn Fiveland, Skien (NO); Dag Arne Eimer, Porsgrunn (NO)

(73) Assignee: STATOIL PETROLEUM AS, Stavanger (NO)

(21) Appl. No.: 13/383,092

(22) PCT Filed: Jul. 12, 2010
(86) PCT No.: PCT/NO2010/000283

§ 371 Date: Mar. 26, 2012

(30) Foreign Application Priority Data
Jul. 10, 2009 (NO) 20092629

(51) Int. Cl. B01D 3/34; B01D 19/00

(52) U.S. Cl. 203/49; 202/185.1

(57) ABSTRACT

A system for desorption of CO₂ from an absorption fluid includes a cylinder with an open inner core, a reboiler including a stripper unit arranged between the inner core and the circumference of the cylinder, where the reboiler including the stripper unit is rotatable arranged around an axis through the core, where the system further includes a condenser rotatable arranged in proximity of the cylinder and rotatable around the same axis, where all the parts of the system are symmetrically arranged around the rotational axis through the core, and where all the fluid paths through the rotational parts of the system are arranged to provide symmetry and weight balance when the system is operational. A method for desorbing CO₂ is also provided.

The present invention relates to an apparatus and a method for removing and recovering CO₂ from flue gases. Furthermore the present invention relates to an apparatus and method for desorption of CO₂ from a liquid absorbent.

During the later years there has been an increased focus on CO₂ capture due to the environmental aspects associated with the release of CO₂ to the atmosphere.

The conventional method for removing CO₂ from flue gas is by use of a standard absorption-desorption process. In this process the flue gas has its pressure boosted by a blower either before or after an indirect or direct contact cooler. Then the flue gas is fed to an absorption tower where it is contacted counter-currently with an absorbent flowing downwards. In the top of the column a wash section is fitted to remove, essentially with water, remnants of absorbent following the flue gas from the CO₂ removal section. The absorbent, rich in CO₂ from the absorber bottom is pumped to the top of a desorption column via a heat recovery heat exchanger rendering the rich absorbent pre-heated before entering the desorption tower. In the desorption tower the CO₂ is stripped by steam, generated in a reboiler positioned at the column bottom. The steam moves up the tower serving as a diluent to the CO₂ although some of the steam condenses to provide desorption heat for the CO₂. Water and absorbent following CO₂ over the top is recovered in the condenser over the desorber top. Vapour is formed in the reboiler from where the absorbent lean in CO₂ is pumped via the heat recovery heat exchanger and a cooler to the top of the absorption column.

EP 0 020 055 A1 teaches how e.g. a gas and a liquid can be contacted counter-currently in a rotating packed bed by introducing the liquid at the core of the bed and the gas from the perimeter. It is further known from Ramshaw (Heat Recovery Systems & CHP, vol 13, no 6, pages 493-513, 1993) that a rotating packed bed could also be fitted with a heat exchanger at the outer perimeter, and that this heat exchanger could be used as a reboiler.

JP1066420 disclose a system for separation CO₂ from a working fluid employing an absorption fluid. The system comprises two rotating cylinders and injection nozzles arranged there between. A desorption system is not disclosed.

The aim of the present invention is to provide a compact desorption system, which is cost efficient both to construct, operate and maintain. Further the present invention aim to reduce the thermal degradation of the absorption solution by limiting the residence time of the absorption fluid in the desorber.

According to the present invention, the abovementioned aim is reached by means of an apparatus and a method according to the enclosed independent claims. Further advantageous features and embodiments are mentioned in the dependent claims.

The present invention can be utilized in connection with gasses coming from different kind of facilities. These facilities could be combined cycle gas fired power plants; coal fired power plants, boilers, cement factories, refineries, the heating furnaces of endothermic processes such as steam reforming of natural gas or similar sources of flue gas containing CO₂.

The present invention can be utilized with any type of liquid CO₂ absorbent, comprising an absorbent and a liquid diluent. Examples of applicable absorbents comprise amine based absorbents such as primary, secondary and tertiary amines; one well known example of applicable amines is mono ethanol amine (MEA). The liquid diluent is selected among diluents that have a suitable boiling point, are stable and inert towards the absorbent in the suitable temperature and pressure interval. An example of an applicable diluent is water.

A advantageous aspect of the present invention is that it is possible to combine several process equipment items, e.g. five process equipment units, or unit functions, into fewer, possibly one, compact units. The reduced size of the unit or units allows a very compact construction, and the unit or units could be assembled on one skid.

In regard to rotating packed beds the present invention represents a solution to the problem of space in the radial direction and difference in centrifugal acceleration between the inner and outer perimeters. that the present invention also provides integrated condensers at a level right next to or above/below the mass transfer and reboiler zones.

The present invention may provide solutions for the following problems associated with existing technology:

The compact technology uses less material, strongly reduces the piping needs, and removes the need to work high above the ground as is needed for a conventional column. This is expected to strongly reduce the cost of the desorption unit.

By allowing much smaller, compact equipment units to be made and through its compactness, the customary receiving vessel and reflux pump may be eliminated. These are traditionally standard and thus on the order of 5 conventional units are replaced.

According to the present invention, the absorption liquid has a very short residence time in the rotating desorber wheel. Due to this, thermal degradation of the absorbent solution is expected to be significantly reduced as compared to conventional solutions.

These and other objectives are obtained by an apparatus according to claim 1 and a method according to claim 9. Other advantageous embodiments and features are set forth in the dependent claims.

The present invention will now be disclosed in further detail with reference to the enclosed figures, wherein:

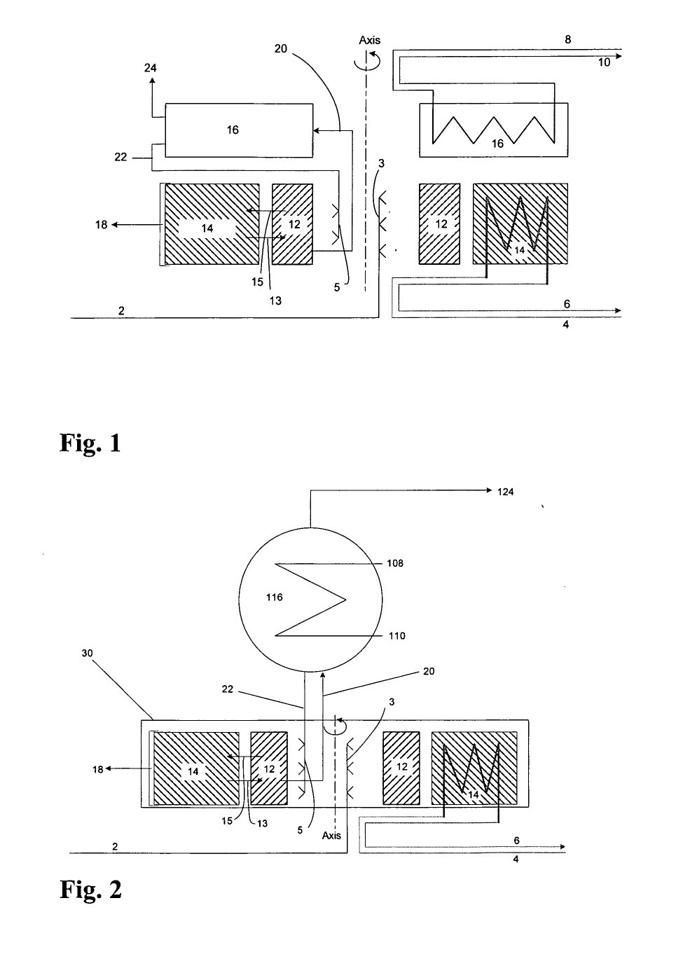

FIG. 1 illustrates a rotating desorber according to a first embodiment of the present invention;

FIG. 2 illustrates a rotating assembly according to a second embodiment of the present invention, the rotating assembly comprising an integrated rotating reboiler and desorber packing and stationary condenser;

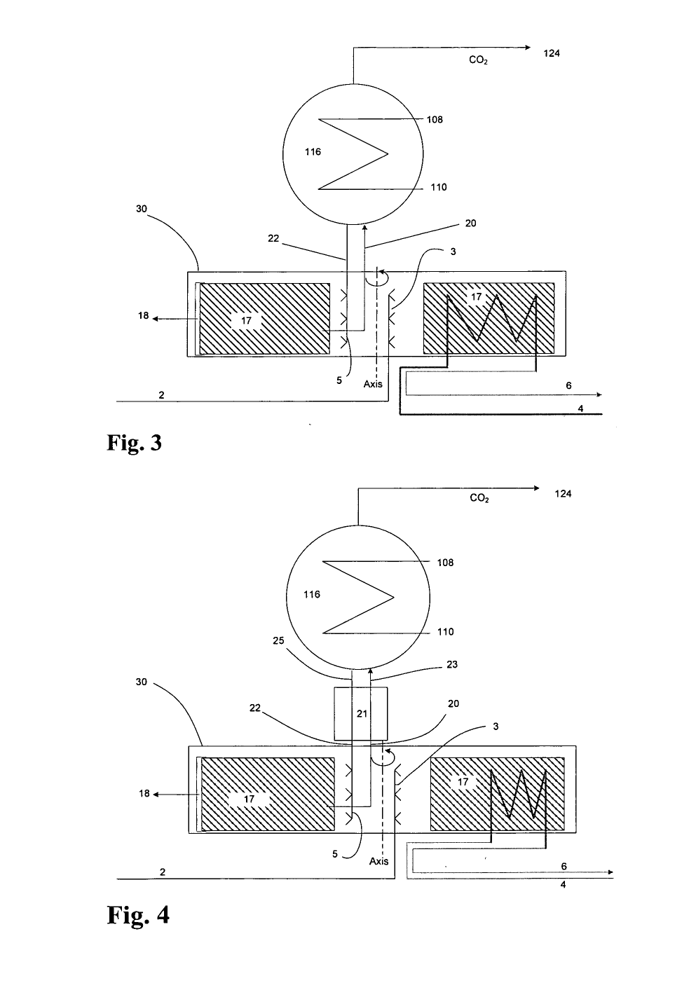

FIG. 3 illustrates a reboil desorber according to a third embodiment of the present invention;

FIG. 4 illustrates the use of an absorbent reflux condenser according to a forth embodiment of the present invention;

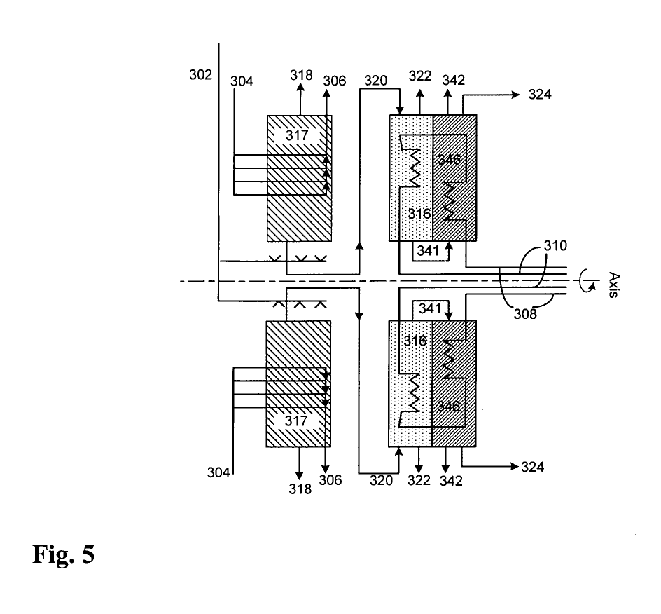

FIG. 5 illustrates an embodiment of a rotating desorber according to a fifth embodiment of the present invention.

In conventional technology on the order of five pieces of equipment are needed in the desorption section, namely the column, a reboiler, a condenser, a condensate receiver vessel, and a reflux pump. According to the present invention these can all be incorporated in one or two pieces of equipment, thus eliminating significant piping connections and process control functions. This simplification leads to direct cost savings, but also significant cost savings with respect to erection, piping and process control can be expected.

With conventional rotating packed beds it is difficult to find enough space in the core area to allow the incorporation of an integrated condenser. According to the present invention these limitations are alleviated, allowing the provision of an integrated condenser at a level above/below or next to the mass transfer and reboiler zones. The present invention thus largely solves the problem of space in the radial direction and the difference in centrifugal acceleration between the inner and outer perimeters.

A further improvement to the process equipment in the desorption process is the reduction in size. Hence less material is used, less area is needed, and erection is further eased.

A first embodiment of the present invention is illustrated on FIG. 1 showing a cross sectional view along a vertical axis of rotation. The equipment comprises a rotating assembly with two levels. At the lower level there is a stripper unit comprising a rotating packed bed 12 next to the inner core. In this desorber packing 12, CO₂ is desorbed from the rich absorbent which is entered through conduit 2 and distributed at the core via nozzles 3. The desorption is achieved mainly by water vapour flowing in a counter-current fashion from the perimeter, and by part of this water vapour condensing thus providing heat for the endothermic desorption of CO₂. The inward vapour flow 13 is created in a reboiler section 14 forming a periphery part of the stripper unit. A part of a liquid 15, which is lean on CO₂ and moving radial outwards due to the rotation, is evaporated caused by condensing steam on the warm side of this heat exchanger/reboiler section. Steam 4 is fed the core and leaves as condensate 6, also at the core after it has supplied heat to reboiler section 14. The liquid 18 is significantly stripped of CO₂ and is allowed to leave the rotating assembly at the outer periphery of the reboiler section 14. The vapour stream 20 reaching the core from the rotating packed bed rises to the upper level where this vapour stream flows outwards in a condenser 16, and where diluent vapour is condensed by a coolant 8 in indirect contact. The heated coolant leaves the condenser at the core as stream 10. At the outer periphery the gas stream 24 leaving the condenser 16 is mainly CO₂ and the stream 24 is fit for drying and compression if needed for sequestration. The liquid stream 22 leaving the outer periphery comprises condensed diluent and absorbent and this stream is returned to the core at the lower level via nozzles 5.

The liquids 2, 22 introduced at the core in the illustrated embodiment are distributed via nozzles. However, other means of feeding liquids may also be envisaged, such as perforated pipes or similar.

FIG. 2 shows a second embodiment of the present invention. Here equal reference numbers are utilized for those parts that are unchanged compared to the first embodiment illustrated in FIG. 1. In the second embodiment the lower level is unchanged compared to the first embodiment in FIG. 1, except for a housing 30 that is added illustrating that the upper level is not part of the rotating assembly. The desorber overhead 20 comprising CO₂, diluent and absorbent is fed to a conventional condenser 116 and brought into indirect contact with a coolant 108. The coolant absorbs heat and leaves through conduit 110. The coolant may be cooling water or another suitable cooling liquid. Liquid condensed in the condenser 116 is returned to the lower level as reflux 22 comprising diluent and absorbent. The vapour stream 124 out of the condenser is will contain the desorbed CO₂ fit for drying and compression if needed for sequestration.

A third embodiment of the present invention is shown in FIG. 3. A desorption section 17 is constructed as a reboiler only without splitting the mass transfer stripping section and the formal reboiler. The reboiler heat transfer area thus doubles as mass transfer area along with the surface of droplets in the section, and all desorption of CO₂ is performed in the reboiler. Since the reboiler design in this invention is by nature a liquid flow through a stripping unit with limited back mixing, the liquid flows radially outwards counter-current to the vapour being created continuously on the reboiler walls. The advantage of this embodiment is a simpler construction compared to the second embodiment illustrated on FIG. 2.

In FIG. 4, a fourth embodiment of the invention, which could be used with either of the embodiments illustrated on FIG. 2 or 3, is shown. The further development consists of a reflux condenser 21 positioned between the rotating entity within the housing 30 and the stationary condenser 116. By applying a limited condensation at this point, it is possible to condense the least volatile vapour component, usually the valuable absorbent, and this separation of absorbent is aided by some water also condensing thus creating a refluxed wetted wall column or equivalent. The desorber overhead 20 is fed into the reflux condenser, and the non-condensed parts of this stream are fed into the main condenser 116. The condensate from the main condenser 116 is fed as stream 25 into the top of the reflux condenser 21. The combined liquid condensate streams are returned to the lower level via conduit 22. This leads to a small distillation taking place.

In another embodiment, not shown, the cold condensate from the main condenser 116 may be routed to some other point of advantage in the process thus reducing the need for heat supply to the reboiler equivalent to heating said condensate to the lean absorbent temperature.

In yet another embodiment the reflux condenser described could be fitted into the core of the rotating entity on the lower level, and rotating with the entity and some condensate from the condenser could be used for reflux.

Although the axis in most of the illustrated embodiments is vertically aligned the rotating axis could also be horizontally aligned. The speed of rotation will make the liquids travel radially thereby forcing the vapour phase to move towards the axis of rotation.

FIG. 5 shows a preferred embodiment of the present invention where the axis of rotation is horizontally aligned. The embodiment has many similarities with the embodiments shown on FIGS. 1 and 3. FIG. 5 illustrates the directions of flow in this embodiment. Similar elements are referred to with similar reference numbers with an addition of 300 for the reference numbers to be distinctive.

FIG. 5 shows an integrated tubular reboiler and stripper. In the illustrated embodiment the reboiler unit 317 is designed with a number of small diameter tubes for heat supply.

Steam is supplied trough conduit 304 and passed trough the tubes running in parallel with the axis of rotation. The tubes are in communication with a conduit 306 for removing the condensate. For the purpose of illustration three tubes are shown on each side of the axis of rotation, however the reboiler may comprise any number of tubes. In this embodiment the stripper is integrated in the reboiler. The CO₂ rich absorbent is introduced via conduit 302 and the stripping will take place when the absorbent solution is introduced to unit 317. Depleted absorbent solution leaves the reboiler unit 317 at the circumference as stream 318. The vapour phase including the CO₂ leaves the reboiler near the centre into conduit 320 and is then directed into a first condenser 316 at the perimeter. In order to create additional surface area for the mass transfer, it is proposed in one aspect of the invention to include layers of thin metal mesh between the rows of reboiler tubes, e.g. 6 mm tubes in 9 mm centre diameter will give a reboiler specific surface of 233 m²/m³. Other dimentions and configurations may of course equally well be used. A fine metal mesh with wire diameter 0.5-1 mm diameter gives specific surface areas above 1000 m²/m³ depending on mesh spacing. The small tubes can be fixed to the end plates using conventional roller expander techniques. In this embodiment it is proposed to use horizontal tubes in the reboiler and omit the slope. This is mainly because of design and manufacturing considerations. This solution requires that the tubes are open in both ends with condensate drainage in the end closest to the condenser section 316. The steam that flows from 304 to 306, from left to right and is gradually converted to condensate and drained to the right through 306. The condensate may be to removed in a fluid mechanical seal located on the stator cylinder at the same axial position, instead of using special return channels to the stator end cover.

In one aspect of the present invention sieve trays or perforated plates are included between the rows of tubes for heat supply instead of thin metal mesh, the sieve trays/perforated plates will increase the area of liquid gas contact and also contribute to enhanced distribution of the liquid phase.

In another aspect of the present invention small spherical elements are included between the rows of tubes.

Due to steam consumption considerations it is preferred to use a design with gas flow towards the rotation centre and absorbent flow towards the periphery. Subsequently the gas must be guided from the centre to the condenser section 316. This can be achieved by including radial flow channels with rigid steel plates.

The embodiment illustrated on FIG. 5 comprises a two stage condenser 316 and 346. Cooling liquid is entered at the centre through conduit 308 and supplied first to the second condenser 346 and thereafter onto the first condenser 316 before the cooling liquid leaves through conduit 310 arranged at the centre. In another aspect of the present invention the cooling liquid is supplied through conduits along the centre but with inlet and outlet from the reboiler side. In the first condenser 316 diluent and absorbent is condensed and will due to the rotation be transported to the perimeter where it leaves the condenser 316 as stream 322. Stream 322 may be returned to the reboiler 317 as reflux. The reflux of condensed vapour, which becomes stream 322, over the gas mixture in the first condenser, is considered to contribute to the elimination of absorbent vapour in the recovered CO₂. In the second condenser 346 mainly diluent free of absorbent is condensed and leaves the condenser as stream 342. If water is used as diluent the obtained water stream from the second condenser may in one aspect of the present invention be utilized as washing liquid in the absorption process to remove traces of the absorbent from the CO₂ depleted flue gas stream. The stream 324 out of the condenser will contain the desorbed CO₂ fit for drying and compression if needed for sequestration.

The configuration of the rotating desorber wheel with two mirrored desorber and condenser sections on each side of the axial centre plane shown in FIG. 5 solves some critical mechanical challenge. The axial load on the desorber caused by the high io pressure steam supplied for heating of the process is more than 100 tons. The symmetry implies that the load on each desorber is eliminated by the load of the opposite desorber. Another advantage is that the mass and energy flow to each part is reduced by 50% which makes the inflow and outflow of liquids/gases easier to handle.

Splitting the reboiler in two sections makes it possible to handle large volumes of absorbent, more than 250 liter per second, which is considered to be a very large volume.

Yet another advantage is that the desorber section is the compact part of the rotor with respect to the mass of steel per unit volume. Splitting the reboiler in two sections and installing them as close as possible to the main bearings of the shaft reduces the mechanical loads of the rotating equipment significantly.

Still another advantage of providing symmetry according to the present invention is that the rotating desorber easily can handle varying volumes of absorbents. A gas power plant or a coal power plant does not operate at 100% all the time and the flue gas volume that needs to be cleaned for CO₂ will vary. The volume of liquid absorbent will thus vary. Since the liquid absorbent is equally distributed to the two reboiler sections, the problems with weight balance is not an issue.

1. System for desorption of CO₂ from an absorption fluid comprising a cylinder with an open inner core, a reboiler comprising a stripper unit arranged between the inner core and the circumference of the cylinder, where the reboiler comprising the stripper unit is rotatable arranged around an axis through the core, where the system further comprises a condenser rotatable arranged in proximity of the cylinder and rotatable around the same axis, where the reboiler comprising the stripper unit and the condenser are symmetrically arranged around the rotational axis through the core, and where all the fluid paths through rotational parts of the system are arranged to provide symmetry and weight balance when the system is operational.

2. System according to claim 1, where the system further comprises a conduit for supplying CO₂ rich absorption fluid to the inner core, an arrangement for discharge of lean absorbent at the outer perimeter of the cylinder, means for heat supply to at least a periphery part of the stripper unit, and a gas outlet arranged in proximity to the inner core.

3. System according to claim 2, where a gas inlet to the condenser is arranged near the outer perimeter of the condenser and a liquid outlet from the condenser is arranged near the gas inlet.

4. System according to claim 1, where the condenser is arranged in proximity of the first end of the cylinder with a fluid inlet in fluid communication with a vapor outlet from the core, a liquid outlet in fluid communication with the core of the cylinder and a CO₂ outlet, and where the condenser is cooled by indirect contact with a coolant through conduits.

5. System according to claim 1, where heat is supplied throughout the whole stripper unit.

6. System for desorption according to claim 1, where the inner part of the stripper unit near the axis is a desorber part without external heat supply whereas the periphery part of the stripper unit is heated as a reboiler.

7. Method for desorbing CO₂ from a CO₂ rich absorption fluid, comprising the steps of feeding the CO₂ rich absorbent to a core of a rotating cylinder comprising an integrated reboiler and stripper unit, supplying heat to at least the periphery part of the stripper unit, removing liquid lean absorbent and diluent from the periphery part of the cylinder, removing vapor comprising CO₂, diluent and lean absorbent from the core part of the cylinder, feeding the vapor comprising CO₂, diluent and lean absorbent to a rotating condenser, and condensing the main part of the vapor comprising CO₂, diluent, and lean absorbent in the rotating condenser, resulting in a liquid stream of diluent and lean absorbent, and a CO₂ rich vapor stream from the rotating condenser.

8. System according to claim 2, where the condenser is arranged in proximity of the first end of the cylinder with a fluid inlet in fluid communication with a vapor outlet from the core, a liquid outlet in fluid communication with the core of the cylinder and a CO₂ outlet, and where the condenser is cooled by indirect contact with a coolant through conduits.

9. System according to claim 3, where the condenser is arranged in proximity of the first end of the cylinder with a fluid inlet in fluid communication with a vapor outlet from the core, a liquid outlet in fluid communication with the core of the cylinder and a CO₂ outlet, and where the condenser is cooled by indirect contact with a coolant through conduits.

10. System for desorption according to claim 2, where the inner part of the stripper unit near the axis is a desorber part without external heat supply whereas the periphery part of the stripper unit is heated as a reboiler.
